(19) United States
(12) Patent Application Publication
(10) Pub. No.: US 2016/0056902 A1
(43) Pub. Date: Feb. 25, 2016

(54) SYSTEMS FOR MODULE AND MODULAR MOBILE ELECTRONIC DEVICE TESTING

(71) Applicant: Google, Inc., Mountain View, CA (US)

(72) Inventors: Paul Eremenko, Mountain View, CA (US); David Fishman, Mountain View, CA (US); Seth Newburg, Mountain View, CA (US); Ara Knaian, Mountain View, CA (US); Marisa Bober, Mountain View, CA (US)

(21) Appl. No.: 14/834,227

(22) Filed: Aug. 24, 2015

Related U.S. Application Data
(60) Provisional application No. 62/040,866, filed on Aug. 22, 2014.

(51) Int. Cl. H04B 17/00; H04M 1/02

(52) U.S. Cl. CPC H04B 17/00; H04M 1/0254

(57) ABSTRACT

A system for module testing includes a module interface that includes a power interface, a data interface, and a mechanical interface; a functional testing system that simulates at least one of power conditions and data conditions for the module; and a model generator, wherein the module generator generates models of a modular mobile electronic device based on module operations data.

### CROSS-REFERENCE TO RELATED APPLICATIONS

This application claims the benefit of U.S. Provisional Application No. 62/040,866, filed on 22 Aug. 2014, all of which is incorporated in its entirety by this reference.

### TECHNICAL FIELD

This invention relates generally to the mobile electronics field, and more specifically to new and useful systems for module and modular mobile electronic device testing in the mobile electronics field.

### BACKGROUND

Current methods of mobile electronic device design create devices that are static, both in terms of functionality and in terms of design. Companies try to solve this problem by producing a wide range of devices having different functionalities and different designs. As a result, users of such devices are forced to make compromises; they lack the ability to customize the functionality and design of their mobile devices to truly meet their needs and preferences. Modular mobile electronic devices may serve to meet user needs and preferences. Like all mobile electronic devices, components of modular mobile electronic devices must undergo testing to ensure reliability and continued operation. Testing is especially difficult for modular mobile electronic devices precisely because of the freedom users have to choose between almost limitless combinations of modules and module configurations; as much as is reasonable, reliability and continued operation must be ensured for all of these combinations. Thus, there is a need in mobile electronics field to create systems for module and modular mobile electronic device testing. This invention provides such new and useful systems.

### BRIEF DESCRIPTION OF THE FIGURES

FIG. 1 is a diagram view of a system of an invention embodiment;

FIG. 2 is a model view of a module interface of a system of an invention embodiment;

FIG. 3 is a diagram view of a functional testing system of a system of an invention embodiment;

FIG. 4 is a diagram view of an environmental testing system of a system of an invention embodiment;

FIG. 5 is a diagram view of a system of an invention embodiment;

FIG. 6 is a model view of a module interface of a system of an invention embodiment;

FIG. 7 is a model view of module interfaces of a system of an invention embodiment;

FIG. 8 is a diagram view of a system of an invention embodiment; and

FIG. 9 is a diagram view of a variation of a system of an invention embodiment.

### DESCRIPTION OF THE INVENTION EMBODIMENTS

The following description of the embodiments of the invention is not intended to limit the invention to these embodiments, but rather to enable any person skilled in the art to make and use this invention.

Systems for module and modular mobile electronic device testing function to test modular mobile electronic devices and modules used for modular mobile electronic devices for reliability and performance in a number of scenarios. More specifically, modules, modular mobile electronic devices, and the systems used to enable modular mobile electronic devices (e.g., controllers, switches, power networks, and/or data networks) should be tested to meet or exceed performance standards in a variety of configurations and environmental conditions, and to appropriately handle errors and excursions.

Modular mobile electronic devices are preferably created and/or modified through the use of user-removable modules. When multiple modules are connected, the modules are preferably enabled, in confederation, to serve as a mobile electronic device. The mobile electronic device created by such a confederation is preferably characterized by the confederated modules as well as the parameters of confederation, which are preferably determined by the confederated modules and any system enabling the confederation of the modules. A modular mobile electronic device configured to serve as a smartphone is an example of a possible mobile electronic device. Other examples of possible mobile electronic devices include those configured to serve as tablets, laptops, media players, cameras, measurement devices, gaming systems, vehicular computing devices, set-top boxes, and televisions.

Modules are preferably user-removable and replaceable, enabling users to create mobile electronic devices with highly varied form and functionality. For example, a user may connect a camera module, a flash memory module, a processor module, a battery module, and a touchscreen LCD module to a modular mobile electronic device to create a small and lightweight camera. The user could later add a cell-phone radio module and a microphone/speaker module to create a camera phone. Modules preferably follow an open and free standard, enabling almost anyone to be a module developer.

The flexibility afforded by module confederation preferably allows for a number of favorable outcomes. Users can purchase only the modules necessary for their needs, allowing for reductions in cost. Users can also choose to replace modules or add additional modules at a later time. In combination, these two outcomes may help increase accessibility to mobile electronic devices (and in many cases, the internet) throughout the world, especially for people for whom a smartphone or a PC is not currently a good value proposition. For example, a user may buy a system and a basic set of modules at a low price point, and transition to a more advanced phone by adding modules later on. These two outcomes may also help slow the creation of electronic waste by allowing mobile electronic devices to be upgraded or modified rather than replaced. Further, because modular mobile electronic devices are compatible with modules of highly varied form and function, and because modules are preferably based on an open standard, module confederation may allow small or specialized companies to make modules playing to their strengths without designing a full mobile electronic device.

Some example module types include sensor modules, processor modules, storage modules, communication modules, display modules, and power modules. Examples of sensor modules include accelerometer modules, GPS modules, camera modules, depth imaging modules, fingerprint reader modules, biometric sensor modules, microphone modules, digital/analog input modules, haptic input modules, infrared flash modules, pedometer modules, barometer modules, magnetometer modules, and gyroscope modules. Examples of processor modules include application processor modules and graphics processor modules. Examples of storage modules include non-volatile flash memory modules and RAM modules. Examples of communication modules include Wi-Fi radio modules, GSM/CDMA radio modules, HDMI connector modules, NFC modules, Bluetooth radio modules, and USB connector modules. Examples of display modules include touchscreen LCD or OLED modules, non-touch graphical display modules, and e-ink display modules. Examples of power modules include battery modules, solar panel modules, and battery charging modules. The variety of modules preferably serve to provide various options and combinations of inputs, outputs, data storage, data processing, communication, power, and other suitable aspects of a computing device. Note that these example module types are in no way exhaustive or exclusive; i.e., modules may incorporate functionality from many of these example types or from none at all, and modules may additionally or alternatively incorporate suitable functionality not herein described.

The following text and figures describe systems for module and modular mobile electronic device testing. The modules and modular mobile electronic devices are preferably those described in U.S. Provisional Application No. 61/976,173 and/or U.S. Provisional Application No. 61/976,195, which are incorporated in their entirety by this reference. The modules and modular mobile electronic devices may additionally or alternatively be any suitable modules and modular mobile electronic devices.

### 1. System for Module Testing

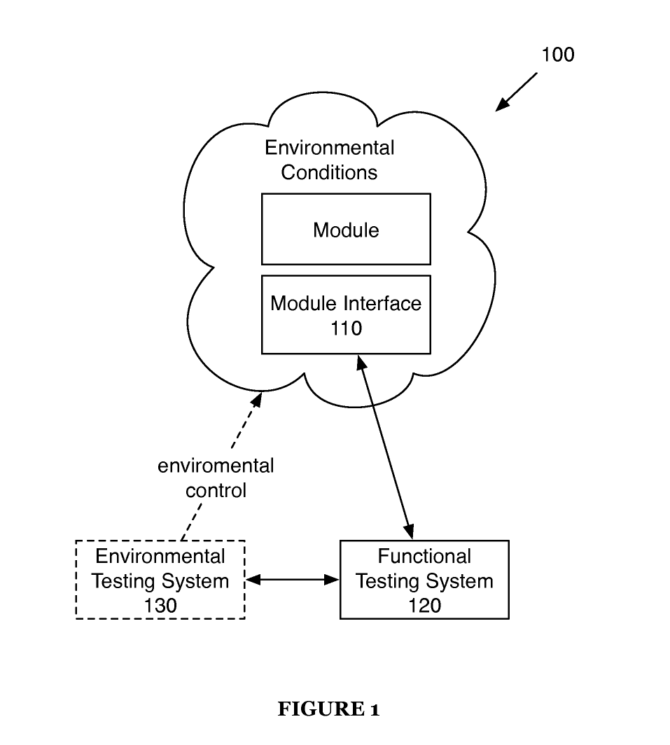

As shown in FIG. 1, a system for module testing 100 includes a module interface 110 and a functional testing system 120. The system 100 may additionally include an environmental testing system 130. The system 100 functions to test modules by exposing them to a large variety of functional conditions (via the functional testing system 120) and a large variety of environmental conditions (via the environmental testing system 130 and measuring the performance and/or reliability of the modules in these scenarios. Functional conditions are preferably implemented by simulated interactions between the module being tested and other modules and/or modular mobile electronic devices, and/or any other scenarios relating to module data and/or power transfer between the module being tested and a modular mobile electronic device. Environmental conditions are preferably implemented by simulated interactions between the module and surrounding environments, including thermal, mechanical, and/or electrical conditions. The functional testing system 120 preferably connects to the module through the module interface 110, and in addition to creating functional scenarios for module testing, preferably also records how modules perform in response to tests of the functional testing system 120. The functional testing system 120 may additionally or alternatively record how modules perform in response to tests of the environmental testing system 130.

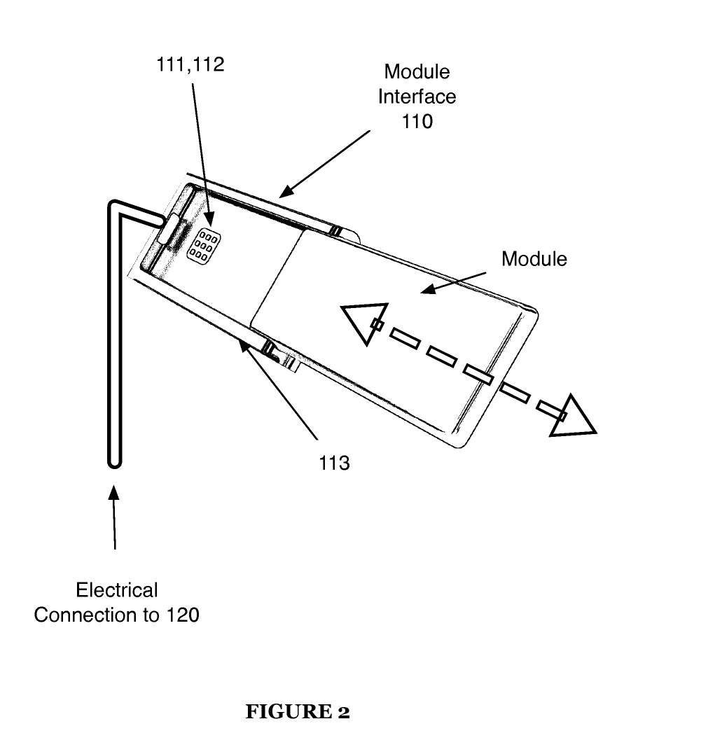

As shown in FIG. 2, the module interface no functions to couple data and/or power connections of the module to the functional testing system 120. The module interface no preferably includes a data interface 111, a power interface 112, and a mechanical interface 113; but may additionally or alternatively only include one or two of interfaces 111, 112, and 113. The data interface in preferably enables data transfer between the module being tested and the functional testing system 120. The power interface 112 preferably enables power transfer between the module being tested and the functional testing system 120. The mechanical interface 113 preferably enables alignment of the module interface 110 with the module being tested and may additionally or alternatively securely hold the module. The module interface 110 is preferably substantially similar to the module interface of U.S. Provisional Application No. 62/040,860, with the exception that the module interface no couples the module to the functional testing system 120 instead of to a modular mobile electronic device, but may additionally or alternatively include be any module interface no capable of allowing power transfer and/or data transfer between the functional testing system 120 and modules being tested. The module interface no is preferably connected to the functional testing system 120 by conductive wires but may additionally or alternatively be connected to the functional testing system 120 by any suitable method.

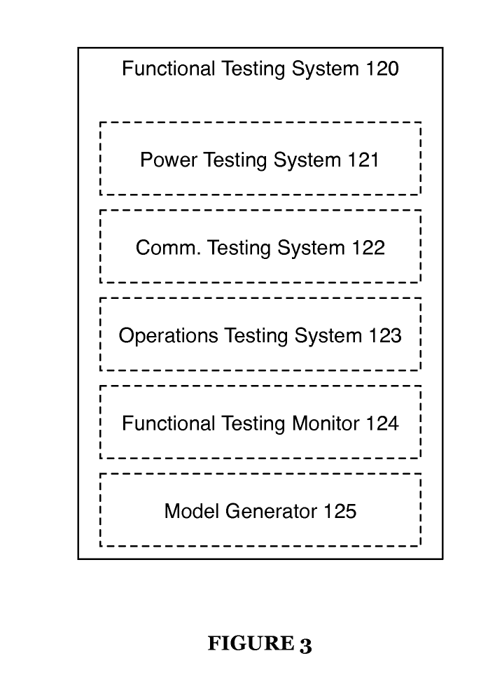

As shown in FIG. 3, the functional testing system 120 functions to expose modules to a variety of functional conditions and measure the response of the modules to these functional conditions. The functional testing system 120 may additionally or alternatively measure responses of the modules to the environmental testing system 130. The functional testing system 120 preferably implements functional conditions by simulating power and data transfer conditions similar to those that could be expected in a modular mobile electronic device (including extreme-case scenarios), and measures response to these conditions. For example, the functional testing system 120 might send data to a module containing errors to determine if the module executes correct error handling protocol. As another example, the functional testing system 120 might provide a voltage outside the operating range of the module to determine if the module correctly responds to the higher voltage (e.g. by sending an error message or disconnecting the module). The functional testing system may include one or more of a power testing system 121, a communication testing system 122, an operations testing system 123, a functional testing monitor 124, and a model generator 125. The functional testing system 120 preferably connects to the module being tested via the module interface 110, but may additionally or alternatively connect to the module being tested in any suitable manner.

The functional testing system 120 preferably is implemented at least in part by a computer, but may additionally or alternatively be implemented by any suitable system.

The power testing system 121 preferably functions to test the module with various conditions relating to power transfer. The power testing system 121 may vary the power supplied to the module in a number of ways, including voltage amplitude, current amplitude, voltage/current waveform, duty cycle, frequency, etc. The power testing system 121 may additionally inject noise of varying types into the supply power. If the module being tested has power storage or power generation capabilities, the power testing system 121 may additionally or alternatively vary the load impedance seen by the module in order to test module power transfer capabilities. The power testing system 121 may additionally interact with other components of the functional testing system 120 to generate situation-specific power transfer conditions; for example, delivering a high voltage pulse after the module has been instructed to go into a sleep power state by the operations testing system 123.

The communications testing system 122 preferably functions to test the module with various conditions relating to communications. The communications testing system 122 may vary the way data is transmitted to the module in a number of ways, including data transmission rate, data transmission waveform (including amplitude, high/low values, duty cycle), data modulation, and data clock synchronization. The communications testing system 122 may additionally inject noise of varying types into the data transmissions. The communications testing system 122 may additionally interact with other components of the functional testing system 120 to generate situation-specific data transfer conditions; for example, communicating at a high bit rate after the module has been instructed to communicate at a lower bit rate by the operations testing system 123.

The operations testing system 123 preferably functions to test the module with various conditions relating to module and modular mobile electronic device operations. More specifically, the operations testing system 123 preferably simulates how a modular mobile electronic device or other module might interact with the module being tested. Simulating a modular mobile electronic device may include sending and receiving commands, sending and receiving data, or performing any other functions that a modular mobile electronic device might conceivably perform. For example, the operations testing system 123 might send the module power state commands (e.g., change from a high power state to a low power state).

In particular, the operations testing system 123 may be used to test module responses to wake and detect operations (e.g., testing that a module wakes up correctly in response to a wake signal and/or does not respond to erroneous wake signals, testing that a module correctly detects the presence of a modular mobile electronic device enablement system).

The operations testing system 123 preferably simulates modular mobile electronic devices based on models describing the behavior of individual modules and the modular mobile electronic device enabled by them. These models may be provided by module and system developers, generated by the model generator 125, or sourced in any other suitable manner. These modules preferably describe the functional behavior of the modules and the modular mobile electronic device; e.g. how the modules and modular mobile electronic device respond to commands, what commands they might send, etc. To simulate modules that produce data (e.g. modules with sensors), the models include example data. As an example, a camera module model might include an example image that could have taken by the camera module.

The operations testing system 123 preferably modifies these models to include specific extreme cases; for example, a module model might include parameters that cause it to behave erratically or send incorrect commands.

The operations testing system 123 preferably tests specific functionality of modules. For example, the operations testing system 123 might test a camera module by sending a request that a camera module take a picture and store it in a (simulated) storage module. This might include sending responses and data as if the operations testing system 123 was a modular mobile electronic device including a storage module. This specific functionality is preferably detailed by the module developer, but may additionally or alternatively be retrieved in any suitable manner.

The operations testing system 123 preferably incorporates extreme scenarios when testing modules; that is, the operations testing system 123 may intentionally send incorrectly formatted or contradictory commands to test how the module handles these scenarios.

The operations testing system 123 preferably integrates with the other components of the functional testing system 120 to generate scenarios particular to certain operational aspects of the module, as previously described.

The functional testing monitor 124 functions to record module response to the testing systems of the functional testing system 120. This may include module power data, module communications data, and/or module operations data. Module power data preferably includes data on how modules send or receive power; for example, power production data (e.g., output voltage, output current, voltage/current waveform, duty cycle, etc.), power storage data (e.g., output voltage, output current, voltage/current waveform, duty cycle, charge rate, capacity, etc.), power consumption data (e.g., current draw, voltage requirements, etc.). Module communications data preferably includes data on how modules transfer data; for example, data transmission rate, data transmission waveform (including amplitude, high/low values, duty cycle), data modulation, and data clock synchronization. Module operations data preferably includes data describing the content of module communications; more specifically, the content of data sent by modules, and how modules respond to data content sent to modules. For example, this could include sending a module a query about the module's functional capabilities and recording the response of the module. In the earlier camera example, module operations data could include the image data transmitted by the camera module and communications data sent to the simulated storage module. Module operations data may additionally or alternatively include module performance and/or reliability data; for example, data resulting from benchmarks run on the module.

The model generator 125 functions to generate models of modules and/or modular mobile electronic devices. The model generator 125 preferably generates models based on module operations data collected by the functional testing monitor 124, but may additionally or alternatively generate models based on module power data and/or module communication data. The model generator 125 may additionally or alternatively generate models based on any other suitable data, including data provided by module developers. For example, the model generator 125 may generate models based on crowdsourced data provided collected automatically from real-world modular mobile electronic device usage. The model generator 125 preferably generates models that simulate behavior of modules and/or modular mobile electronic devices. These models preferably include example data for simulated input if the module is an input device (e.g. a simulated camera module model preferably includes a sample image). These models preferably may be modified or designed to include extreme-case scenarios; for example, the previously mentioned camera module model might include scenarios that simulate common error modes of the camera model, edge case scenarios, or any other suitable scenarios designed to test the limits of modules attached to the functional testing system 120.

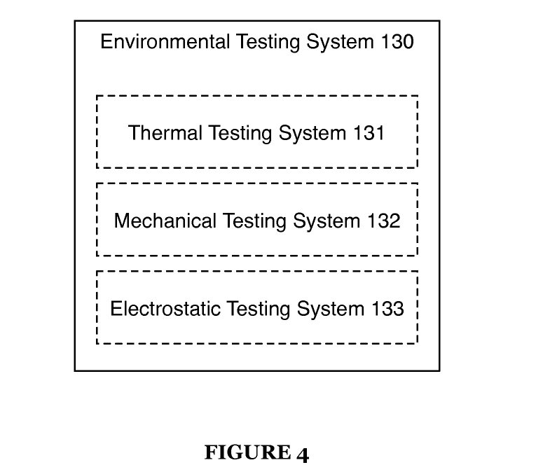

As shown in FIG. 4, the environmental testing system 130 functions to expose modules to a variety of environmental conditions. The environmental testing system 130 may additionally also record data on the response of the modules to these environmental conditions. The environmental testing system 130 preferably includes a thermal testing system 131, a mechanical testing system 132, and an electrostatic testing system 133. The environmental testing system 130 may additionally or alternatively include any suitable testing systems for exposing modules to environmental conditions. In one example, the environmental testing system 130 includes a testing system that exposes the module to electromagnetic radiation (e.g. radio waves, light, etc.) in order to test the module under these conditions. In another example, the environmental testing system 130 includes a testing system that exposes the module to various chemical environments.

The environmental testing system 130 may coordinate with the functional testing system 120 to test various functional aspects of the module given different environmental conditions; for example, the performance of the module might be measured at a variety of temperatures.

The thermal testing system 131 functions to expose the module to a variety of thermal conditions. The thermal testing system 131 preferably also functions to expose the module to a variety of humidity conditions. The thermal testing system 131 preferably exposes the modules to a wide variety of humidities and ambient temperatures over varying time intervals. The thermal testing system 131 in particular preferably exposes the modules to frequent and rapid extreme temperature and humidity changes, such as those that might occur when transitioning from a humid and hot tropical environment into an air-conditioned environment. The thermal testing system 131 preferably includes heating/cooling elements and humidifying/dehumidifying elements. Some of these elements may be implemented in the module interface 110; for example, if the thermal testing system 131 may include a thermoelectric device in the module interface no to simulate temperature changes of the modular mobile electronic device. The thermal testing system 131 may additionally or alternatively include temperature and/or humidity sensors. The thermal testing system 131 may expose the module to uniform temperature changes, but may additionally or alternatively locally heat the module to produce temperature gradients across the module.

The mechanical testing system 132 functions to expose the module to shock and vibration conditions. The mechanical testing system 132 may additionally or alternatively expose the module to any other mechanical conditions; for example, the mechanical testing system 132 may expose the module to mechanical stress by compressing the module. The mechanical testing system 132 preferably includes mechanical shock inducing components (e.g. a shock table) and mechanical vibration inducing components (e.g. a vibrating table), but may additionally or alternatively include any components suitable for mechanical testing of the module. The mechanical testing system 132 preferably exposes the module to levels of shock and vibration that simulate real world use; for example, the shock table may provide a shock corresponding to the module being dropped from a height of four feet.

The mechanical testing system 132 may additionally or alternatively function to check modules for coupling compatibility (e.g., determining if a module can mechanically couple successfully and securely to a modular mobile electronic device). The mechanical testing system 132 may, for example, include a mechanical interface substantially similar to a modular mobile electronic device mechanical interface; if a module does not fit in the mechanical interface, this may be an indicator of mechanical coupling issues. Likewise, the mechanical interface may also be used to check module retention (e.g. verifying that an electropermanent magnet of a module results in satisfactory coupling strength). The mechanical testing system 132 may additionally or alternatively determine module fit, attachment compatibility, and/or coupling mechanism functionality by measuring module dimensions or by another other suitable methods.

The electrostatic testing system 133 functions to expose the module to electrostatic discharge conditions. The electrostatic testing system 133 preferably includes an electrostatic discharge (ESD) simulator with a human body model output circuit to simulate ESD from human contact. The electrostatic testing system 133 may additionally or alternatively include a charged device model output circuit to simulate ESD that results when the module itself has an electrostatic charge and discharges due to metal contact. The electrostatic testing system may additionally or alternatively include any suitable tools for generating electrostatic discharge conditions.

### 2. System for Modular Electronic Device Enablement System Testing

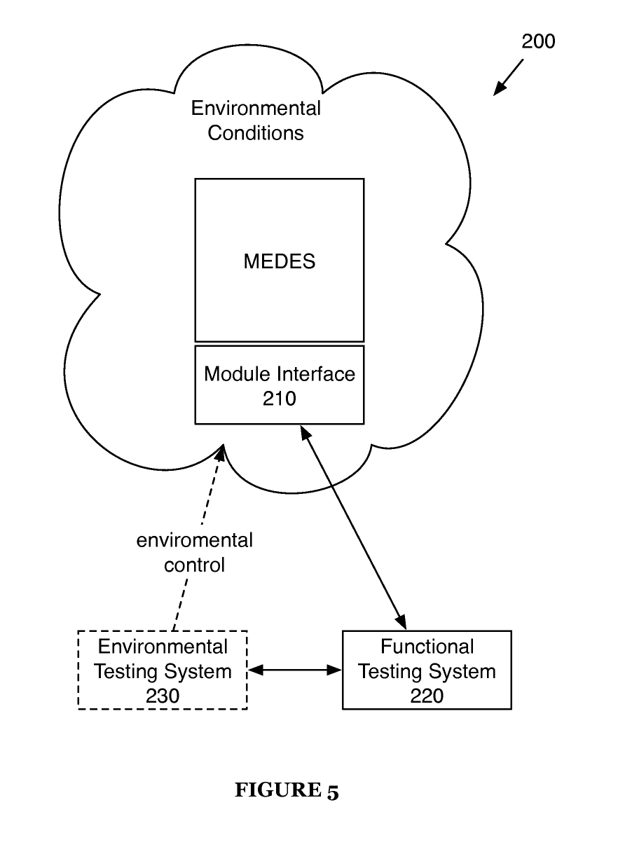

As shown in FIG. 5, a system for modular electronic device enablement system (MEDES) testing 200 includes a module interface 210 and a functional testing system 220. The system 100 may additionally include an environmental testing system 230.

The modular electronic device enablement system (MEDES) is preferably the MEDES of U.S. Provisional Application No. 61/976,195, but may additionally or alternatively be any suitable system capable of receiving modules to create a modular mobile electronic device. The MEDES is preferably mounted within the chassis of U.S. Provisional Application No. 61/976,195, but may additionally or alternatively be mounted within any structure capable of receiving modules to create a modular mobile electronic device.

The system 200 functions to test MEDESs by exposing them to a large variety of functional conditions (via the functional testing system 220) and a large variety of environmental conditions (via the environmental testing system 230) and measuring the performance and/or reliability of the MEDESs in these scenarios. Functional conditions are preferably implemented by simulated interactions between the MEDES being tested and other modules, and/or any other scenarios relating to module data and/or power transfer between the MEDES being tested and other modules. Environmental conditions are preferably implemented by simulated interactions between the MEDES and surrounding environments, including thermal, mechanical, and/or electrical conditions. The functional testing system 220 preferably connects to the MEDES through one or more module interfaces 210, and in addition to creating functional scenarios for MEDES testing, preferably also records how MEDESs perform in response to tests of the functional testing system 220. The functional testing system 220 may additionally or alternatively record how modules perform in response to tests of the environmental testing system 230.

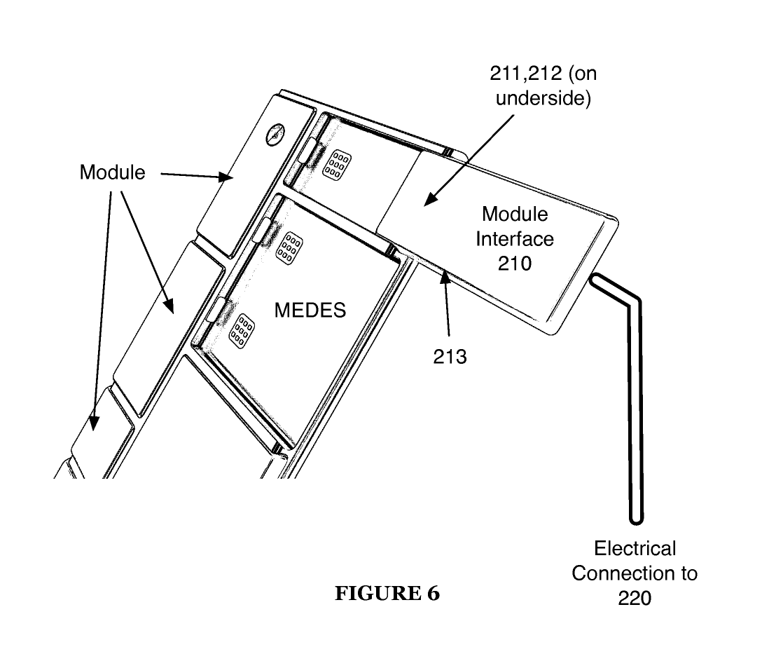

As shown in FIG. 6, the module interface 210 functions to couple data and/or power connections of the MEDES to the functional testing system 220. The module interface 210 preferably includes a data interface 211, a power interface 212, and a mechanical interface 213; but may additionally or alternatively only include one or two of interfaces 211, 212, and 213. The data interface 211 preferably enables data transfer between the MEDES being tested and the functional testing system 220. The power interface 212 preferably enables power transfer between the MEDES being tested and the functional testing system 220. The mechanical interface 213 preferably enables alignment of the module interface 210 with the MEDES being tested. The module interface 210 is preferably substantially similar to the module interface of U.S. Provisional Application No. 62/040,860 but may additionally or alternatively be any module interface capable of connecting to a MEDES and allowing power transfer and/or data transfer to and/or from the MEDES being tested. The module interface 210 is preferably connected to the functional testing system 220 by conductive wires but may additionally or alternatively be connected to the functional testing system 220 by any suitable method.

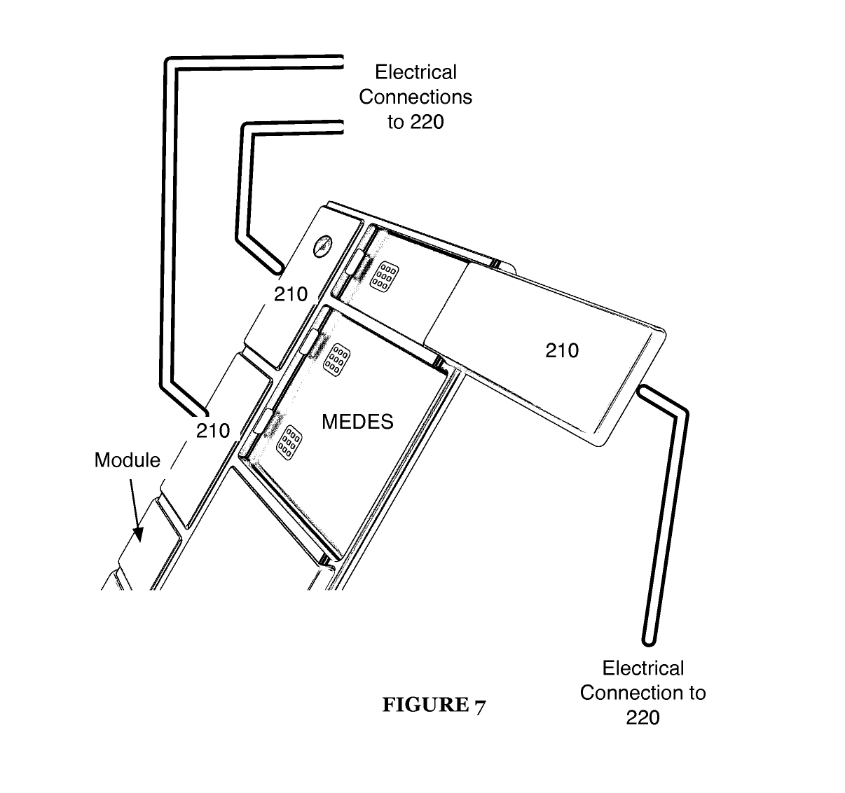

As shown in FIG. 7, multiple module interfaces 210 may be connected to a MEDES to test the MEDES, with each being able to simulate or replicate functions of individual modules. Additionally or alternatively, both modules and module interfaces 210 may be connected to the MEDES to simulate the addition of modules to a modular mobile electronic device or to test modules and MEDESs together.

This latter scenario may be useful for a system 200 operated by a modular mobile electronic device end user. Such a user may be able to use a module interface 210 to debug the operation of a module operating with a MEDES and/or a MEDES. In this way, a user may be able to identify whether a system issue is occurring because of a particular module, a MEDES, or some interaction between modules and the MEDES.

The functional testing system 220 and the environmental testing system 230 are preferably substantially similar to the functional testing system 120 and the environmental testing system 130, with the exception that the systems operate on a MEDES and/or MEDES-enabled modular mobile electronic device instead of on a single module.

### 3. System for RF Testing

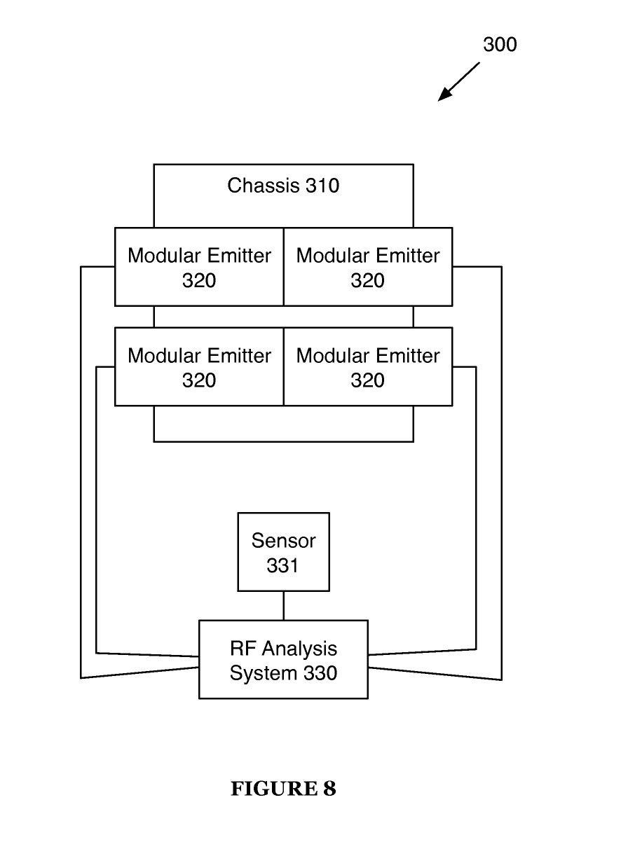

As shown in FIG. 8, a system for radio-frequency (RF) testing 300 includes a modular mobile electronic device chassis 310, a modular emitter 320, and an RF analysis system 330.

The system 300 functions to simulate RF emission from a modular mobile electronic device (through the combination of the chassis 310 and one or more modular emitters 320) in order to determine RF emission characteristics (e.g., specific absorption rate, electromagnetic interference, electromagnetic compatibility, radiated power, isotropic sensitivity). The system 300 preferably allows for RF emission extreme-case scenarios to be simulated, so that RF emission characteristics may be determined in those extreme-case scenarios.

In a first variation of an invention embodiment, the system 300 additionally functions to measure RF emission characteristics of modules and/or MEDESs, and/or to measure module/MEDES performance and reliability in a variety of RF emission scenarios.

The modular mobile electronic device chassis 310 functions to approximate RF characteristics of a modular mobile electronic device chassis, and thus is preferably substantially similar to the chassis of U.S. Provisional Application No. 61/976,195. The chassis 310 may additionally or alternatively include additional RF measurement sensors. The modular mobile electronic device chassis 310 may additionally or alternatively be any suitable structure capable of coupling to the module emitters 320.

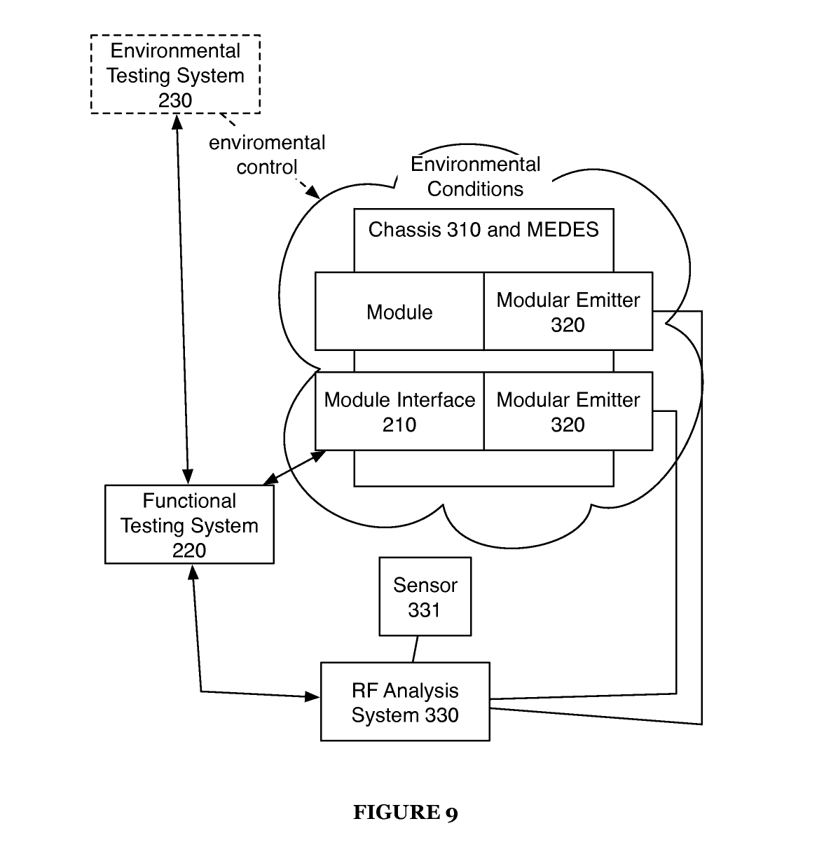

In the first variation of an invention embodiment, the modular mobile electronic device chassis 310 includes a MEDES and is capable of holding both module emitters 320 and modules as previously described, as shown in FIG. 9.

The modular emitter 320 functions to serve as an RF emitter for purposes of approximating RF emissions that might come from a modular mobile electronic device. The modular emitter 320 preferably contains at least one RF antenna, and is preferably driven by the RF analysis system 330. The modular emitter 320 may additionally or alternatively be driven by a MEDES or any other suitable source. The modular emitter 320 is preferably tunable in emission frequency and emission power, but additionally or alternatively may be static in one or either. The antenna(e) of the modular emitter 320 preferably may be removed or changed, but may additionally or alternatively be non-removable. The modular emitter 320 is preferably driven by the RF analysis system to simulate emission from a module, but may additionally or alternatively be driven in any suitable manner to produce RF radiation.

The RF analysis system 330 preferably includes an RF emission sensor 331. The RF analysis system 330 functions to control the modular emitter(s) 320, and to analyze the RF emissions sensed by the RF emission sensor 331 in order to determine RF emission characteristics (e.g., information related to conducted and radiated emissions). These RF emission characteristics are preferably analogous to those that could be produced by a modular mobile electronic device. The RF emission characteristics are preferably used to determine specific absorption rate (SAR), but may additionally or alternatively be used to determine electromagnetic interference (EMI) and/or electromagnetic compatibility (EMC).

In the first variation of an invention embodiment, the RF analysis system 330 additionally functions to measure RF emission characteristics of modules and/or MEDESs, and/or to measure module/MEDES performance and reliability in a variety of RF emission scenarios. In this variation, the RF analysis system 330 may send commands or otherwise control the modules and or MEDESs through module interfaces substantially similar to the module interfaces 110 and 210. The RF analysis system 330 may also integrate with either of the systems 100 and 200 in order to measure module/MEDES performance and reliability in a variety of RF emission scenarios.

The RF emission sensor 331 is preferably an EMF meter or any other suitable sensor capable of detecting RF radiation. The RF emission sensor 331 is preferably a broadband sensor, but may additionally or alternatively be a narrowband sensor. The RF emission sensor 331 may be integrated into a sensor holder that simulates human tissue (for purposes of estimating SAR). The RF emission sensor 331 is preferably connected to the RF analysis system 330.

The RF analysis system 330 preferably controls the modular emitters 320 and/or modules/MEDES through modular interfaces to emit RF radiation at a variety of frequencies and power levels. The RF analysis system 330 preferably records data from the RF emission sensor 331 to determine characteristics of the emitted RF radiation; for example, frequency, emitted power, absorbed power, and/or spectral information. From this data, the RF analysis system preferably estimates specific absorption rate (SAR). The RF analysis system 330 may direct modular emitters 320 to simulate module RF emission.

In the first variation of an invention embodiment, the RF analysis system 330 preferably communicates with the system 200 to test modules and/or MEDESs in the presence of modular emitters 320 or other emitters (e.g., antennas in modules or MEDESs). In this variation, the RF analysis system preferably exposes the modules/MEDES to RF radiation at a variety of frequencies and power levels while the system 200 assesses module/MEDES performance and reliability, as described in the description of the system 200, as shown in FIG. 9.

As a person skilled in the art will recognize from the previous detailed description and from the figures and claims, modifications and changes can be made to an invention embodiments of the invention without departing from the scope of this invention defined in the following claims.

We claim:

1. A system for module testing comprising:
a module interface that includes a power interface, a data interface, and a mechanical interface; wherein the power interface enables power transfer between the system and a module, the data interface enables data transfer between the system and the module, and the mechanical interface mechanically couples the system to the module;
a functional testing system that simulates at least one of power conditions and data conditions for the module; wherein the functional testing system includes a functional testing monitor that records module response data in response to tests of the functional testing system; and
a model generator, wherein the module generator generates models of a modular mobile electronic device based on module operations data.

2. The system of claim 1, wherein the functional testing system comprises a power testing system; wherein the power testing system varies power conditions supplied to the module coupled to the module interface and the functional testing monitor records module power data in response to the power conditions.

3. The system of claim 1, wherein the functional testing system comprises a communications testing system; wherein the communications testing system varies data transfer conditions of the module coupled to the module interface and the functional testing monitor records module communications data in response to the data transfer conditions.

4. The system of claim 1, wherein the functional testing system comprises an operations testing system; wherein the operations testing system simulates aspects of a modular mobile electronic device for the module coupled to the module interface and the functional testing monitor records module operations data in response to the operations testing system; wherein the operations testing system tests wake and detect responses for the module; wherein the operations testing system simulates aspects of the modular mobile electronic device based on models generated by a model generator.

5. The system of claim 1, wherein the model generator generates models of a modular mobile electronic device based on interactions between two modules coupled to the system.

6. The system of claim 1, wherein the model generator generates models of a modular mobile electronic device based on data collected automatically from real-world modular mobile electronic device usage.

7. The system of claim 1, further comprising an environmental testing system, wherein the environmental testing system exposes the module to at least two environmental conditions and records environmental data; wherein the functional testing system performs one simulation in each environmental conditions and compares module response data based on the at least two environmental conditions.

8. The system of claim 7, wherein the environmental testing system comprises a thermal testing system, wherein the thermal testing system varies ambient temperature conditions experienced by the module and the environmental testing system records module data of the module in response to the thermal testing system.

9. The system of claim 7, wherein the environmental testing system comprises a mechanical testing system, wherein the mechanical testing system exposes the module to vibration and shock conditions and the environmental testing system records module data of the module in response to the vibration and shock conditions.

10. The system of claim 7, wherein the environmental testing system comprises an electrostatic testing system, wherein the electrostatic testing simulates electrostatic discharge conditions on the module and the environmental testing system records module data of the module in response to the electrostatic discharge conditions.

11. A system for modular electronic device enablement system (MEDES) testing comprising:
a module interface that includes at least one of a power interface, a data interface, and a mechanical interface; wherein the power interface enables power transfer between the system and a MEDES, the data interface enables data transfer between the system and the MEDES, and the mechanical interface mechanically couples the system to the MEDES; and
a functional testing system that simulates at least one of power conditions and data conditions for the MEDES; wherein the functional testing system includes a functional testing monitor that records MEDES response data in response to tests of the functional testing system; and
a model generator, wherein the module generator generates module models based on module operations data.

12. The system of claim ii, wherein the functional testing system comprises a power testing system; wherein the power testing system varies power conditions supplied to the MEDES coupled to the module interface and the functional testing monitor records MEDES power data in response to the power conditions.

13. The system of claim ii, wherein the functional testing system comprises a communications testing system; wherein the communications testing system varies data transfer conditions of the MEDES coupled to the module interface and the functional testing monitor records MEDES communications data in response to the data transfer conditions.

14. The system of claim 11, wherein the functional testing system comprises an operations testing system; wherein the operations testing system simulates aspects of a module for the MEDES coupled to the module interface and the functional testing monitor records module operations data in response to the operations testing system.

15. The system of claim 14, wherein the operations testing system simulates aspects of the module based on models generated by a model generator.

16. The system of claim 11, further comprising an environmental testing system, wherein the environmental testing system exposes the MEDES to at least two environmental conditions and records environmental data; wherein the functional testing system performs one simulation in each environmental conditions and compares MEDES response data based on the at least two environmental conditions.

17. The system of claim 16, wherein the environmental testing system comprises a thermal testing system, wherein the thermal testing system varies ambient temperature conditions experienced by the MEDES and the environmental testing system records MEDES data of the MEDES in response to the thermal testing system.

18. The system of claim 16, wherein the environmental testing system comprises a mechanical testing system, wherein the mechanical testing system exposes the MEDES to vibration and shock conditions and the environmental testing system records MEDES data of the MEDES in response to the vibration and shock conditions.

19. The system of claim 16, wherein the environmental testing system comprises an electrostatic testing system, wherein the electrostatic testing simulates electrostatic discharge conditions on the MEDES and the environmental testing system records MEDES data of the MEDES in response to the electrostatic discharge conditions.

20. The system of claim 13, further comprising an environmental testing system, wherein the environmental testing system exposes the MEDES to at least two environmental conditions and records environmental data; wherein the functional testing system performs one simulation in each environmental conditions and compares MEDES response data based on the at least two environmental conditions; wherein the environmental testing system comprises a thermal testing system, wherein the thermal testing system varies ambient temperature conditions experienced by the MEDES and the environmental testing system records MEDES data of the MEDES in response to the thermal testing system.
